(19) United States
(12) Patent Application Publication
(10) Pub. No.: US 2009/0259550 A1
(43) Pub. Date: Oct. 15, 2009

(54) System and Method for Management of Advertisement Campaign

(75) Inventors: Christopher C. Mihelich, Somerville, MA (US); Jonathan A. Kelner, Boston, MA (US)

Correspondence Address: NIXON PEABODY, LLP, 300 S. Riverside Plaza, 16th Floor, CHICAGO, IL, 60606, US

(73) Assignee: LeadGen LLC, Newton, MA (US)

(21) Appl. No.: 12/410,145

(22) Filed: Mar. 24, 2009

Related U.S. Application Data
(60) Provisional application No. 61/040,639, filed on Mar. 28, 2008.

(51) Int. Cl. G06Q 30/00; G06N 5/02

(52) U.S. Cl. 705/14.42; 705/14.71; 705/14.69; 705/14.46; 706/54; 706/52

(57) ABSTRACT

Disclosed herein are systems and methods for keeping records and managing allocation in advertising campaigns according to rational quantitative models. In one facet, various quantitative methods are presented to efficiently manage experimentation and reallocation of advertising resources among many opportunities, seeking the best available return on investment. In an additional facet, a number of automated tools are described that keep statistics and manipulate bids and active sets in large advertising campaigns. For instance, in one illustrative embodiment, a system is presented for calculating an estimate of the relationship between position and bid for ad sites on an ad service which defines position. In another exemplary embodiment, an ad-campaign management system is presented which includes a cost-side reporter, a revenue-side reporter, a Bayesian value generator, and a bid generator.

### CLAIM OF PRIORITY AND CROSS-REFERENCE TO RELATED APPLICATION

This application claims the benefit of and priority to U.S. Provisional Patent Application No. 61/040,639, filed on Mar. 28, 2008, the contents of which is hereby incorporated by reference in its entirety.

### TECHNICAL FIELD

The present invention relates generally to the management of advertising campaigns, and more particularly to automated systems for allocating money in an advertising campaign, and methods for performing the same.

### BACKGROUND OF THE INVENTION

An advertiser wants the largest increase in profitable business from the smallest outlay on advertisement practicable, but an optimal advertising strategy is likely unobvious in a practical case. It is common for an advertiser to have many places to advertise for different costs and different results that are not known a priori. Some initial guesswork cannot be avoided, and later on, an advertiser who can afford to continue advertising for a long time will need to assess the effectiveness of the ad placements and perhaps drop and add several ad sites from the campaign.

The Internet offers a variety of advertising services that provide many different advertising options in one place with a unified interface. Several search engines now offer “pay-per-click” (PPC) search advertising, in which an advertiser may sign up to have a short plain-text advertisement appear atop or alongside search results for a set of potential search phrases of the advertiser's choice. Each search phrase is the subject of a continuous auction among advertisers interested in advertising on that phrase. Advertisers have a standing bid on each search phrase, which they may modify at will with reasonably prompt effect, stating the most they are willing to pay each time a user clicks through their ads on that keyword. To a first approximation, advertisers with larger bids appear in more prominent positions on the search-results pages, and consequently receive more clicks (and pay more money apiece).

There are also “cost-per-impression” (CPI or CPM) programs that charge a given amount per impression—i.e., for each time a user is shown the ad in a page of search results, and “cost-per-action” (CPA) programs in which an advertiser pays for each occurrence of a given action that is beneficial to him (for instance, each time that a user clicks through the ad and goes on to fill out a form on the advertiser's website). In a superficially different direction, there are many advertisement servers that can serve text, image, or video advertisements anywhere on a wide network of websites. Advertisers bid on criteria matching websites on which they think it useful to advertise, so that these criteria take the place of search phrases in search-engine PPC advertising. Regardless, the same structure is present—i.e., many available advertising spaces with different performance characteristics.

The search-engine PPC industry uses analytical software to automatically maintain basic statistics on sales, traffic, and expenses for search keywords. Search engines' PPC programs have built-in graphical interfaces that make it easy to view, sort, and manually modify bids, as long as the manipulations are not too intricate. These tools, however, leave plenty to be desired, both in analytics and in interfaces. The need for sound quantitative methods has only increased with the recent abundance of advertising space created by the Internet.

The PPC analytics tend to treat key phrases individually, and compute their conversion probability, the chance that a click through an ad will generate revenue for the advertiser, by dividing the keyword's conversions by its clicks. This all works well enough in a campaign where the keywords draw a lot of traffic, the advertising budget is large enough to bid on all of them for a substantial period, and the campaign has been running for a while. For example, if a key phrase has 40 conversions on 1000 clicks, its conversion probability is probably in the neighborhood of 40/1000=4%. But in a campaign with many lightly trafficked keywords, the results will be unsatisfying. A keyword with a conversion rate of 2% (not atypical in the business) having only 4 clicks will typically have gone 0-for-4 and occasionally 1-for-4, giving naïve estimated probabilities of 0% (no money in it, give up now) and 25% (it converts all the time, bid to the moon!), both of which are dangerously misleading results.

The manual interfaces are also problematic in a campaign with many keywords having little information. Manual management relies too heavily on often dubious human probabilistic intuition, and expends too much human time and patience in such a campaign. The situation calls for a sound mathematical method for making these decisions automatically.

Such weaknesses are crippling in a “long-tail” campaign, in which an advertiser seeks to generate business by advertising on a large number of modestly trafficked keywords that are not too competitively bid upon rather than by advertising on obviously heavily trafficked keywords that are predictable subjects of fierce bidding wars (for instance, a small entity trying to outbid deep-pocketed banks on the keyword “mortgage” will probably fail). A long-tail campaign always abounds in keywords that have few clicks, so conventional analytics are useless, and a long-tail campaign is unwieldy to manage by hand because there are so many keywords.

### SUMMARY OF THE INVENTION

In view of the aforesaid deficiencies in the known current practices in quantitative management of advertising campaigns, developed and claimed herein are several methods and automated systems for keeping records and managing allocation in advertising campaigns according to rational quantitative models. As part of one facet, various quantitative methods are presented to efficiently manage experimentation and reallocation of advertising resources among many opportunities, seeking the best available return on investment. In yet another facet, a number of automated tools are described that keep statistics and manipulate bids and active sets in large advertising campaigns.

According to one embodiment of the present invention, a system and method is presented for fitting a model function to data on an ad site's totals of chargeable events and conversions by optimizing the logarithm of a maximum likelihood estimator through a variant of a simulated-annealing simplex method, such as the simplex method of Press, Teukolsky, Vetterling, and Flannery, Numerical Recipes, 3rd ed., sections 10.5 and 10.12, modified to handle inequality constraints correctly. The model to be fit to data may be taken piecewise-linear, and the objective function (i.e., the function to be optimized) may be the usual objective function plus a penalty term. The penalty term may be a constant multiple of the total variation of the piecewise-linear model to help prevent overfitting.

In another embodiment, a system and method is described for calculating an information value for an ad site based on its totals of chargeable events and conversions by embedding this valuation problem in a Markov decision process whose optimal valuation may be found by an efficient one-dimensional iterative process.

In yet another embodiment of the present invention, a bidding system and method for ad services that define position is provided. A user may specify an amount of money to try to spend on the entire ad campaign. The system then uses a volume model and a position model to calculate for each ad site the cost and revenue expected from a sampling of bidding levels, and a set of bids that efficiently allocate spending among the ad sites is determined by a greedy algorithm.

According to another embodiment, a system and method is presented for estimating the average volume of chargeable events expected on an ad site for each position in which the ad site may appear in an ad service that defines position. In one aspect, the calculation uses data on chargeable events and, if there exists a concept of impression in the ad service and that concept is distinct from that of chargeable event, also data on impressions. The system fits a certain model to the data obtained from a cost-side reporter and a revenue-side reporter by phrasing the problem as a least-squares problem amenable to standard methods of linear algebra.

Presented in even yet another embodiment, a system and method for calculating an estimate of the relationship between position and bid for ad sites on an ad service that defines position. In one exemplary application, for each ad site and each ad position, the system computes a suitable weighted central statistic, such as the mean or median, of weighted points determined by each reporting period's bid and position for that ad site. The system converts the function associating each position to its weighted central statistic into a similar monotonic function, which is then returned.

In even yet another embodiment of the present invention, an ad-campaign management system is provided. The ad-campaign management system comprises four primary components: a cost-side reporter, a revenue-side reporter, a Bayesian value generator, and a bid generator. The cost-side reporter is operable to receive signals from an ad service, and output signals bearing data relating to activity of ad sites, such as chargeable events. The revenue-side reporter is operable to receive signals from another system, such as a commercial website or company database, and output signals bearing data relating to conversions associated with the chargeable events.

The Bayesian value generator is operable to receive signals from the cost-side reporter and revenue-side reporter, and output an estimated average value of a chargeable event on that ad site. The Bayesian value generator comprises a conversion-probability estimator, a conversion-value estimator, and an information-value estimator. The conversion-probability estimator is configured to generate data for each ad site stating the estimated conversion probability of that ad site. The conversion-value estimator is configured to generate data stating for each ad site the estimated average value of a conversion on that ad site. The information-value estimator is configured to generate data for each ad site stating the estimated monetary equivalent value of the information that could be gained about that ad site by bidding high on that ad site for a limited time. The bid generator is configured to calculate for each ad site in a campaign a bid to be applied to that ad site, and to output a signal bearing data relating to the calculated bids.

The conversion-probability estimator may be further configured to specify a statistic S(·) and for each ad site a prior distribution φ, and to compute the estimated conversion probability. The conversion-value estimator may be further configured to receive as input signals or user-configurable parameters one or more additional values to be included in the calculation to regularize the case of sparse data. The information-value estimator may be further configured to receive input signals from the cost-side reporter, the revenue-side reporter, the conversion-probability estimator, and the conversion-value estimator. The output of the Bayesian value generator for an ad site may be in the form of x₁x₂+x₃, where xi denotes the output of the i-th element in the above enumerated list for that ad site.

The above embodiments, features, and advantages, and other embodiments, features, and advantages of the present invention, will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a block diagram schematically illustrating a computer system upon which aspects of the present invention may be implemented and practiced;

FIG. 2 is a block diagram schematically illustrating electronic communication links between components of a bidding system in accordance with one embodiment of the present invention; and

FIG. 3 is a flow chart diagrammatically illustrating a chain of nested groups and corresponding ranges of plausible central statistics associated with each group.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE PREFERRED EMBODIMENTS

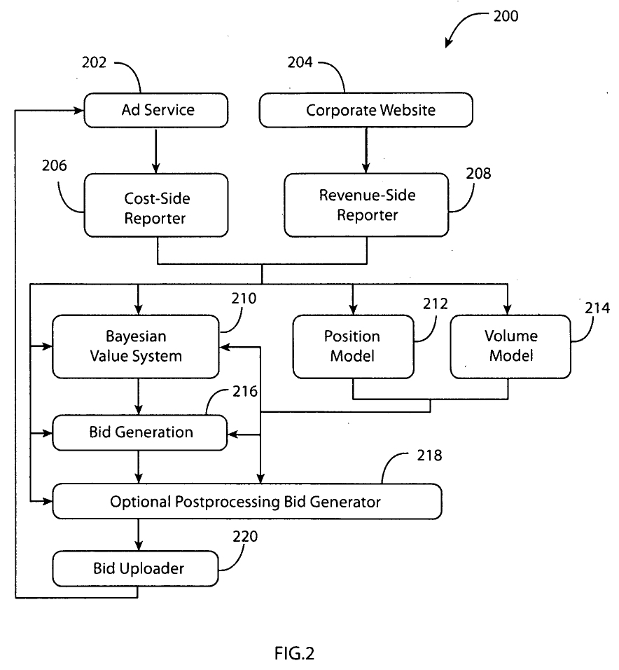

For ease of explanation and clarification, certain basic terminology is defined hereinbelow. Referring to the drawings, wherein like reference numbers refer to the same or similar components throughout the several views, FIG. 2 schematically illustrates a bidding system, indicated generally at 200, in accordance with one embodiment of the present invention.

An “ad service”, which is represented schematically in FIG. 2 at 202, is a business operation that offers advertisers the opportunity to establish, and from time to time modify with reasonably prompt effect, the data within an ad campaign. The data contained in an ad campaign may include the following:
1. zero or more “ad sites”, to with, situations in which advertisements could be shown, whose range of permissible values is determined by the ad service;
2. for each ad site in datum 1, zero or more advertisements offered to be displayed in that ad site from time to time at the ad service's discretion; and
3. for each ad site in datum 1, a “bid” in units of money to control the expense associated with the advertisements on that ad site. It is expected that on average, increasing the bid on an ad site will not decrease the overall frequency of display of the set of advertisements submitted by the advertiser for that ad site.

The ad service defines a notion of a “chargeable event” on an advertisement. For the privilege of offering advertisements for display in the ad account, the advertiser must pay for each chargeable event occurring on one of the advertiser's displayed advertisements an amount of money that may depend on instantaneous market conditions and other unknown factors, but will never exceed the advertiser's bid in effect on the ad site in which the charged advertisement was displayed when the chargeable event occurred. The ad service may at its option define “minimum bids” for one or more ad sites, and decline to display advertisements in ad sites for which the advertiser's bid is lower than the minimum bid for that ad site. If defined, the minimum bid on an ad site may vary between advertisers, and the ad service may change it at will. If the minimum bid is not defined, we consider the minimum bid to be zero.

On demand, or frequently and on a regular schedule, the ad service provides the advertiser reports of activity for each “reporting period”, to with, each contiguous time interval with a certain alignment and size specified by the ad service (e.g., a calendar day beginning at midnight EDT). The activity report for a reporting period must specify for each ad site a bid that was in effect for that ad site during some part of that reporting period, the number of chargeable events occurring on that ad site during that reporting period, and the minimum bid (if any) currently required on this ad site. The activity report may contain further information at the ad service's discretion.

An ad service in which several advertisements can be displayed simultaneously in one ad site may optionally define a notion of “position” of an advertisement, which describes the placement of the advertisement relative to the other advertisements, if any, that displayed simultaneously with the given advertisement. If defined, the notion of position shall take positive-integer values in such a way that greater values in the position set correspond to typically less desirable relative placements, and higher bids on a fixed ad site shall on average lead to lesser or equal positions of the advertisements in that ad site (i.e., to placements that are no less desirable). If position is defined, the activity report for a reporting period must report for each ad site the average position (or a similar central statistic on position) in which advertisements were shown in that ad site, provided that at least one advertisement was shown in that ad site during that reporting period. If an ad service defines a notion of “position” that violates one or more of these requirements, we treat it as an ad service in which position is not defined.

A “conversion” is a money-making transaction, associated to a showing of an ad on an ad site, beginning with a customer's initiating contact with the advertiser in a way that can be traced to the showing of that ad on that ad site. The meaningful attributes of a conversion are the resulting revenue, the ad site from which it arose, and the reporting period in which it arose.

A “cost-side reporter”, designated as 206 in FIG. 2, is a software and/or hardware system for receiving activity records periodically from an ad service 202, and maintaining and reporting their relevant contents to other parts of a computer system or systems, such as the Bayesian Value Generator 210, Bid Generator 216, Post Processing Bid Generator 218, or any combination thereof. This includes for each site its number of chargeable events in various time ranges. The design of the cost-side reporter 206 depends most heavily on the advertising service 202 it is intended to interact with.

A “revenue-side reporter”, indicated at 208 in FIG. 2, is a software and/or hardware system for receiving, maintaining, and reporting records regarding conversions—e.g., for each conversion, its associated revenue, and the reporting period and ad site in which it was initiated. In certain embodiments, the advertiser's own corporate/business website (see 204 in FIG. 2) or other business logic must provide most of this information. The revenue-side reporter outputs its generated data to other parts of the computer system or systems, such as the Bayesian Value Generator 210, Bid Generator 216, Post Processing Bid Generator 218, or any combination thereof.

A “Bayesian value system”, represented schematically at 210 in FIG. 2, is a software and/or hardware system that uses information from the cost-side and revenue-side reporters 206, 208 to estimate for each ad site the expected value in units of currency arising from one chargeable event on that ad site, preferably performing the computation according to the following pattern. The value of an ad site may be calculated by multiplying the product of the estimated conversion probability of that ad site with the estimated average revenue of conversions on that ad site and adding an optional “information value” (typically zero in algorithms that do not choose to define it) that encourages exploratory bidding-up on keywords that are relatively untested or seem promising for some special reason. The estimated conversion probability μ is calculated as S(ψ), where S(·) is a fixed statistic and ψ is the distribution whose cumulative distribution function equals:

$$PR \{ μ \leq x \} = \frac{{\int }_{0}^{x} {{μ}^{a} ( 1 - μ )}^{b} φ ( μ ) d μ}{{\int }_{0}^{1} {{μ}^{a} ( 1 - μ )}^{b} φ ( μ ) d μ}$$

Here, a is the number of conversions of the ad site; b is the number of chargeable events on the ad site that did not result in conversions; and φ is a probability distribution associated to the ad site by the algorithm in some way (this is intentionally left unspecified because the algorithms may choose φ in different ways). This is the conditional probability distribution of the conversion probability assuming a prior distribution of φ and given the data of conversions and chargeable events observed.

In the context of an ad service that defines position, a “position model”, seen in FIG. 2 at 212, is a software and/or hardware system that uses information from the cost-side and revenue-side reporters 206, 208 to estimate for each ad site the relationship between bids on that ad site and the typical positions that result from those bids.

In the context of an ad service that defines position, a “volume model”, shown as 214 in FIG. 2, is a software and/or hardware system that uses information from the cost-side and revenue-side reporters 206, 208 to estimate for each ad site the average chargeable events expected to be received by that ad site in one future reporting period as a function of the ad site, the position in which its advertisement appears, and the reporting period.

A “bid generator”, shown schematically as 216 in FIG. 2, is an executable program, invoked periodically by a recurrent process or manually by a human user, that calculates new bids to be applied to the ad sites in a campaign, using information from the cost-side and revenue-side reporters 206, 208 as needed, and stores the result in a form readable to a bid uploader.

A “bid uploader”, seen as 220 in FIG. 2, is an executable program, generally invoked after an execution of a bid generator 216, that reads a bid generator's output and transmits those bids to the ad service. FIG. 2 of the drawings diagrams the interactions between these subsystems.

The position model 212 and volume model 214 are considered optional, and in particular may not exist if the ad service 202 does not define position. Likewise, if the optional postprocessing bid generator 218 is absent from the system 200, the bid generator 216 sends output directly to the bid uploader 220. The bid uploader 220 is also optional; if absent, its input stream is instead the output signal of the bidding system.

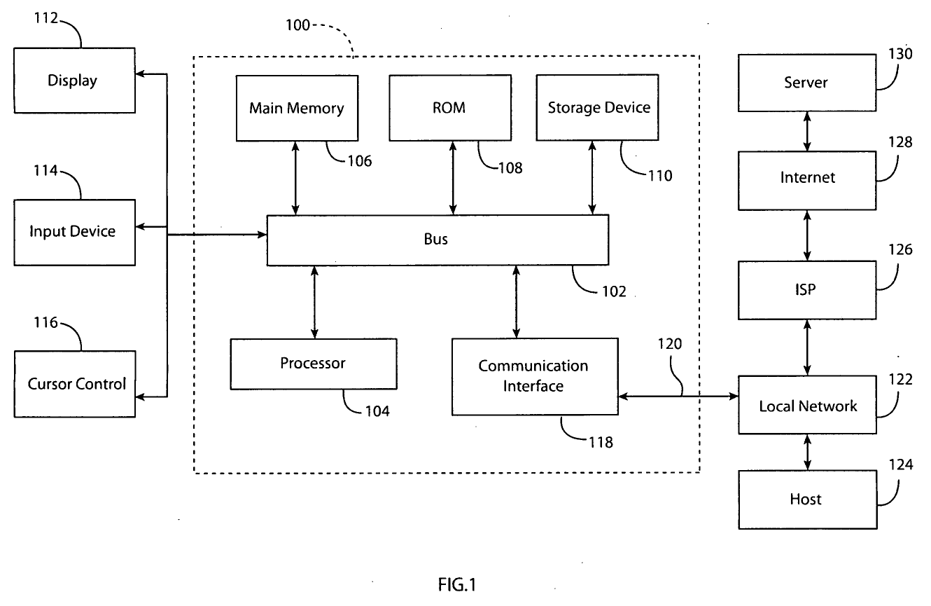

Referring to the drawings, wherein like reference numbers refer to like components throughout the several views, FIG. 1 shows a block diagram that schematically illustrates a computer system 100 upon which aspects of the present invention may be implemented. Although described below, in parts, in the singular, the present concepts are implementable on a computer system comprising more than one processor in one or more locations. The depicted representation of a computer 100 includes a bus 102 or other communication mechanism for communicating information, and a processor 104 coupled with bus 102 for processing information. Computer 100 also includes a main memory 106, such as a random access memory (RAM) or other dynamic storage device, coupled to bus 102 for storing information and instructions to be executed by processor 104. Such instructions may comprise instructions relating to the management of advertising campaigns or ad sites in accord with at least some aspects of the disclosed concepts including, but not limited to, a bid generator 216 and/or a bid uploader 220. Main memory 106 also may be used for storing temporary variables or other intermediate information during execution of instructions to be executed by processor 104. Computer 100 further includes a read only memory (ROM) 108 or other static storage device coupled to bus 102 for storing static information and instructions for processor 104, such as information received from the bid generator 216 and/or instructions received from the bid uploader 220. A storage device 110, such as a magnetic disk, optical disk, or solid state memory device, is provided and coupled to bus 102 for storing information and instructions.

Computer 100 may be coupled via bus 102 to a display 112 for displaying information to a computer user. An input device 114, which may include keyboards with alphanumeric and other keys, touch screen interfaces, microphones, and the like, is coupled to bus 102 for communicating information and command selections to processor 104. Other types of user input device include a cursor control 116, such as a mouse, a trackball, or cursor direction keys, for communicating direction information and command selections to processor 104, and for controlling cursor movement on display 112.

The invention is related to the use of a computer 100, or a computer system comprising one or more computers, for managing allocation of advertising campaigns responsive to ad site performance. According to at least some aspects of the present concepts, methods of managing allocation of advertising campaigns responsive to ad site performance or generating bids for advertising campaigns are provided, at least in part, by computer 100 in response to processor 104 executing one or more sequences of one or more instructions contained in main memory 106 or read into main memory 106 from another computer-readable medium, such as storage device 110.

Alternatively, methods in accord with the present concepts may be implemented in a distributed computing environment (DCE) involving multiple computers remote from each other wherein each computer has a role in a computation problem or information processing. Such a DCE comprising computer 100 may include a network comprising a plurality of nodes interconnected by communication paths (e.g., a bus, star, Token Ring, and mesh topology) arranged in a local area network (LAN), metropolitan area network (MAN), or wide area network (WAN). Thus, for example, the present concepts are amenable to dissemination amongst a plurality of local and/or remote processing systems (e.g., a client/server communication model) with a first portion of the analysis done on a PC at a first user's location, a second portion of the analysis done in a remote computer at a second location, and a third portion of an analysis provided at a third computer or processor at a third location, and so on.

Execution of the sequences of instructions contained in main memory 106 causes the processor 104 to perform the process steps/instructions described herein, in whole or in part. One or more local and/or remote processors in a multi-processing arrangement may also be employed to execute the sequences of instructions contained in main memory 106 or in another local or remote memory. In alternative embodiments, hard-wired circuitry may be used in place of or in combination with software instructions (e.g., firmware) to implement at least some aspects of the concepts disclosed herein. Thus, embodiments of the invention are not limited to any specific combination of hardware circuitry, firmware or software.

The term “computer-readable medium” as used herein refers to any medium that participates in providing instructions to processor 104 for execution. Such a medium may take many forms, including but not limited to, non-volatile media, volatile media, and transmission media. Non-volatile media include, for example, optical or magnetic disks, such as storage device 110. Volatile media include dynamic memory, such as main memory 106. Transmission media may include, but is certainly not limited to, coaxial cables, copper wire and fiber optics, including the wires that comprise bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave, or any other medium from which a computer can read.

Various forms of computer readable media may be involved in carrying one or more sequences of one or more instructions to processor 104 for execution. For example, the instructions may initially be borne on a magnetic disk of a remote computer. The remote computer can load the instructions into its dynamic memory and send the instructions over a telephone line using a modem or over a network communication link (e.g., a T1 connection). A modem local to computer 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic, optical, or other signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network—e.g., Internet 128. Local network 122 and Internet 128 both use electrical, electromagnetic or optical signals that carry digital data streams. The signals through the various networks and the signals on network link 120 and through communication interface 118, which carry the digital data to and from computer 100, are exemplary forms of carrier waves transporting the information.

Computer 100 can send messages and receive data, including program code, through the network(s), network link 120, and communication interface 118. In the Internet example, a server 130 might transmit a requested code for an application program through Internet 128, ISP 126, local network 122 and communication interface 118. One such downloaded application could, for example, provide for managing allocation of advertising campaigns responsive to ad site performance as described herein, whereas another such downloaded application may only provide for an instruction set sub-portion (e.g., a Bayesian value system, a bid generator, etc.) utilizable in such a managed application of advertising campaign resources. The received code may be executed by processor 104 as it is received, and/or stored in storage device 110, or other non-volatile storage for later execution. In this manner, computer 100 may obtain application code in the form of a carrier wave.

### Details of Simulated-Annealing Simplex Method

In one embodiment of the present invention, a system and method is provided for fitting a model function to data on an ad sites' totals of chargeable events and conversions, such as the system represented schematically in FIG. 2, designated generally therein at 200. In one facet of this embodiment, the system may fit the model function to the data by optimizing the logarithm of the maximum likelihood estimator through a variant of a simulated-annealing simplex method modified to handle inequality constraints correctly. One exemplary simulated-annealing simplex method is presented by Press, Teukolsky, Vetterling, and Flannery, Numerical Recipes, 3rd ed., sections 10.5 and 10.12, which is incorporated herein by reference in its entirety. The term “simplex method” more commonly refers to a well-known algorithm for solving linear programs; the term, however, is not being used in this sense in this document.

Unlike other prior approaches, the present exemplary embodiment is concerned with finding (approximately in floating-point arithmetic) a local minimum of a given function f: U→R, where U⊂Rⁿ is the locus of finitely many inequalities li(\vec{v})≦ξᵢ, where each constraining function li(\vec{v}) is convex. The letters \vec{v} and \vec{w} and subscripted versions thereof denote vectors in Rⁿ (usually in U).

The system can be configured to fit any model φ_{\vec{v}}, to data received from cost-side and revenue-side reporters specifying each ad site's totals of chargeable events and conversions, where each φ_{\vec{v}} is a probability distribution supported in [0, 1] and the parameter \vec{v} ranges through a subset U⊂Rⁿ of the kind specified above. For instance, the system may perform the fitting by finding a reasonably good local minimum of the negative logarithm of the likelihood estimator, namely:

$$f ( \vec{v} ) = - {\sum }_{i} log {\int }_{0}^{1} {φ}_{\vec{υ}} ( μ ) {{μ}^{ai} ( 1 - μ )}^{{b}_{i}} d μ , \qquad ( 1 )$$

where i runs through ad sites in the campaign, aᵢ denotes the number of conversions on i, and bᵢ denotes the number of chargeable events that did not result in conversions. In accordance with one aspect of the present concept, the model to be fit to data is taken piecewise-linear and the objective function is the usual objective function in equation (1) plus a penalty term, which helps to reduce overfitting. The penalty term is a constant multiple of the total variation of the piecewise-linear model. Both systems use a new form of a simulated-annealing simplex method, such as the one of Press et al., to perform the minimization.

### Preexisting Simplex Method

An existing simplex method is discussed hereinbelow without the nuance of simulated annealing for contrast with the novel method presented in the next section. The existing simplex method may require an unconstrained optimization problem, so U=Rⁿ in this instance.

The simplex method is first sketched without the nuance of simulated annealing. (Full details are available in Press et al. loc. cit., at section 10.5.) The method may keep track of n+1 points in [symbol] ⁿ in general position (so their convex hull is a simplex) and the values of f at those points; in a sense, such a configuration is the smallest amount of information about the values of f that says something about the local variation of f in any direction (for just n points would be contained in an (n−1)-dimensional hyperplane, and the values of f at those points would say nothing about the shape of f in the direction perpendicular to that hyperplane). The method may iteratively change the shape of the simplex in an attempt to flow downhill until converging on a local minimum. Several reasonable notions of convergence are available. Without limitation, one convergence criterion is to stop when the absolute difference between the highest and lowest function values at vertices of the simplex is less than a small parameter times the largest absolute value of a function value at a vertex.

An iteration follows the following control structure. Let \vec{v}₁ denote the vertex where f takes its highest value at the beginning of the iteration; let \vec{v}₂ denote the vertex where f takes its second highest value at the beginning of the iteration; and let \vec{v} denote the vertex where f takes its lowest (i.e., best) value at the beginning of the iteration.
1. (Reflect: try moving the worst point to the other side of the simplex to find smaller function values.) Let \vec{w} denote the reflection of \vec{v}₁ through the face of the simplex opposite \vec{v}₁. If f (\vec{w})<f (\vec{v}₁), replace \vec{v}₁ and go to step 2; otherwise leave \vec{v}₁ unchanged and proceed to step 3.
2. (Dilate: move further in that direction if the function continues to decrease that way.) If f(\vec{v}₁)>f(\vec{v}) (recall that \vec{v}₁ has been changed in step 1), this iteration is over. Otherwise let \vec{w} be the dilation of \vec{v}₁ by a factor of 2 from the face opposite \vec{v}₁. Replace \vec{v}₁ with \vec{w} if f(\vec{w})<f(\vec{v}₁). This iteration is over.
3. (Retreat: with high ground on both sides, move into the valley, i.e., closer to the reflection face.) If f(\vec{v}₁)<f(\vec{v}₂), i.e., if \vec{v}₁ is not still the worst point, this iteration is over. Otherwise, let w be the dilation of \vec{v}₁ by a factor of ½ from the face opposite \vec{v}₁. If f(\vec{w})<f(\vec{v}₁), replace \vec{v}₁ with \vec{w}, and this iteration is over. Otherwise go to step 4.
4. (Contract: everything looks high on this scale, so zoom in.) Dilate each vertex \vec{v}′ other than {right arrow over (\hat{v} by a factor of ½ from the point {right arrow over (\hat{v}. This iteration is over.
   Upon convergence, the method returns the best (e.g., lowest) of the function values at the vertices.
   Simplex Method with Convex Constraints

The existing simplex method is modified in accordance with one aspect of the present invention in a novel way to perform optimization in a convex subset U⊂ [symbol] ⁿ as described above. Care must be taken not to move a vertex of the simplex outside of U; in fact it is not desirable to move a vertex too close to the boundary of U in one step. Fortunately, it is enough to keep proposed replacement vertices within appropriate bounds; because U is convex, the entire simplex lies inside U if its vertices lie inside U.

Several user-configurable positive real parameters rₒ, r_{f}, rₘ, Rₒ, R_{f}, c are now defined. In general, these values must satisfy the relations rₒ≧1, rₒ, ≧r_{f≧}r_{m≧}c, Rₒ>rₒ, R_{f}>r_{f}, and 1>c>0. Without limitation, one set of reasonable values is rₒ=3/2, r_{f}=1, rₘ=½, Rₒ=3, R_{f}=2, and c=½.

In accord with at least one aspect of the present concepts, the control structure of an iteration in the simplex method is replaced with the following:
1. (Reflect.) Let d₁ denote the largest value not exceeding Rₒ such that the dilation of \vec{v}₁ through the centroid of the opposite face by a factor of −d₁ lies in U. If d₁<rₘ, go to step 4. Otherwise let d₂=min{d₁,rₒ}rⱼ/rₒ and let \vec{w} denote the dilation of \vec{v}₁ through the centroid of the opposite face by a factor of −d₂. If f(\vec{w})≦f (\vec{v}₁) save the value of \vec{v}₁, replace \vec{v}₁ with \vec{w} and go to step 2; otherwise leave \vec{v}₁ unchanged and go to step 3.
2. (Expand.) Let d₃=d₁R_{f}/Rₒ and let \vec{w} denote the dilation of the old value of \vec{v}₁ through the centroid of the opposite face by a factor of −d₃. If f(\vec{w})≦f(\vec{v}₁), replace \vec{v}₁ again by \vec{w}. In either case this iteration is over.
3. (Retreat.) If f(\vec{v}₁)<f(\vec{v}₂), this iteration is over. Otherwise let \vec{w} be the dilation of \vec{v}₁ by a factor of c through the centroid of the opposite face. If f(\vec{w})<f(\vec{v}₁), replace \vec{v}₁ with \vec{w} and this iteration is over. Otherwise go to step 4.
4. (Contract.) Dilate each vertex \vec{v}′ other than {right arrow over (\hat{v} by a factor of c from the point {right arrow over (\hat{v}. This iteration is over. The method is otherwise unchanged from the previous section.

### Simulated Annealing

Like other downhill optimization methods, prior simplex methodology can easily come to rest in a very suboptimal local minimum, even though lower function values exist nearby. A “simulated-annealing” procedure may be introduced into the instruction set that enables the simplex method to take some steps uphill to escape bad local minima. For instance, some proposed changes to the algorithm presented in the above example regarding the simplex method with convex constraints include:
At the beginning of an iteration, compute for each current simplex vertex the sum of the function value at that vertex and a random deviate. Use this sum in place of the actual function value in comparisons during this iteration.
When testing a proposed replacement point, use the difference of the function value there and a random deviate in place of the function value for comparisons during this iteration.

In one particular embodiment, this procedure always accepts a replacement point that is truly better, but it has a nonzero probability of accepting a replacement point that is modestly worse, thus allowing limited uphill movement in an overall downhill trend. The random deviates are logarithmically distributed, i.e., they have the shape − [symbol] log X for a uniform deviate X ε[0,1] and a parameter [symbol] >0 that decreases gradually according to an annealing schedule. Without limitation, one reasonable annealing schedule specification is the following: initially [symbol] = [symbol] ₒ, and after every N rounds replace [symbol] with ηκ, where κₒ>0 and 0<η<1 are real parameters, and N is a positive integer, typically on the order of 100.

In one exemplary application, the system deduces the tallies aᵢ and bᵢ from input signals from the cost-side and revenue-side reporters and then uses the simplex method with convex constraints and simulated annealing to optimize (1) for whatever model φ_{\vec{v}} it is configured to use. The system may then output a description of the (approximately locally) optimal φ_{\vec{v}} to be used in a Bayesian value generator. The system may also specialize φ_{\vec{v}} to be piecewise linear. Specifically, let m be a user-configurable positive-integer parameter. Then \vec{v} is a (2ₘ+1)-dimensional vector whose components we label as:

\vec{v}=(x₁, x₂, . . . xₘ, v₁, . . . , vₘ₊₁).

For convenience, we may define v₀=1, x₀=0, and xₘ₊₁=1. The permissible region U is that in which vᵢ≧0 and 0≦xᵢ≦1 and xᵢ+ε≦xᵢ₊₁ for all indices i, where ε>0 is a small user-configurable parameter such as, without limitation, the number 10⁻⁴; these are convex conditions. The piecewise-linear distribution φ\vec{v} is defined by the properties that it is linear in each interval [xᵢ, xᵢ₊₁] and takes the values φ\vec{v} (xᵢ)=vvᵢ, where v>0 is taken so that

$${\int }_{0}^{1} {φ}_{\vec{v}} ( μ ) d μ = 1.$$

Directly optimizing the function (1) may overfit the very pliable piecewise-linear model. Responsively, optionally added to (1) is a penalty term, noted above, given by:

$$λ {\sum }_{1 \leq i \leq m + 1} \vert {v}_{i} - {v}_{i - 1} \vert ,$$

where λ>0 is a user-configurable parameter (in practice λ=1 is sufficient). The penalty term punishes excessive oscillation so that the model found by the optimization will fluctuate less violently.

### Computing Information Value for Ad Site

In another embodiment, the systems of the present invention may also be employed for computing an information value for an ad site, given, for example, its numbers of conversions and chargeable events as well as its estimated conversion probability and estimated conversion value. In one representative approach, the system calculates an information value for an ad site based on its totals of chargeable events and conversions by embedding this valuation problem in a Markov decision process whose optimal valuation can be found by an efficient one-dimensional iterative process.

By way of clarification, and without limitation, a model problem involving a sort of information value in the simplest possible setting is constructed and analyzed, and a decision between two alternatives is presented. The same general approach presented in this model may be applied to determine information values of ad sites, as discussed hereinafter.

Let 0<λ<Λ<1 be given probabilities and 0<γ<1 a given real parameter called the “discount rate” (typically close to 1 in our applications, such as 0.99). Consider the following “two-armed bandit game” for one player involving a free slot machine with two levers. In each round of play of this example, the player must pull either lever 1 or lever 2. The player knows that each lever pull has two possible outcomes: receiving a payoff of 1 unit or receiving nothing. Moreover, one lever has a constant payoff probability of λ, while the other has a constant payoff probability of Λ. The only unknown is which lever is the good one. The game continues forever, and the player seeks to maximize the total “discounted” payoff of his plays over all rounds, where the discounted payoff of round i≧0 is γⁱ times the actual payoff. Naturally he wants to come as fast as possible into a pattern of always pulling the good lever, but some experimentation with both levers figures to be necessary to figure out which lever is most likely the good lever.

This problem has the structure of a Markov decision process whose states are the quadruples of nonnegative integers (a₁, b₁, a₂, b₂), where aᵢ and bᵢ are the numbers of successful and unsuccessful pulls, respectively, of lever i. It may be desirable to compute the valuation of the optimal strategy, namely, the function V(a₁, b₁, a₂, b₂) whose value is the expected total discounted payoff starting from the given state. It is computationally convenient, however, to translate this problem from the awkward four-dimensional state space to an equivalent one-dimensional space, as is performed in accord with some aspects of the present concepts presented below.

### Reduction to One Dimension

In a state (a₁, b₁, a₂, b₂), the likelihood that lever 1 is the good lever is Λ^{a}^{₁}(1−Λ)^{b}^{₁}λ^{a}^{₂}(1−λ)^{b}^{₂}, and the likelihood that lever 2 is the good lever is λ^{a}^{₁}(1−λ)^{b}^{₁}Λ^{a}^{₂}(1−Λ)^{b}^{₂}. Consequently, in terms of the ratio r:

$$r = \frac{{{Λ}^{{a}_{1}} ( 1 - Λ )}^{{b}_{1}} {{λ}^{{a}_{2}} ( 1 - λ )}^{{b}_{2}}}{{{λ}^{{a}_{1}} ( 1 - λ )}^{{b}_{1}} {{Λ}^{{a}_{2}} ( 1 - Λ )}^{{b}_{2}}}$$

the probability that lever 1 is the good lever is r/(1+r), and the probability for lever 2 is 1/(1+r).

The ratio r, in fact, contains all the relevant information about a state. Indeed, the transition probabilities are computable from r, and the effect of each transition on r depends only on r, not on the state exponents; for instance, a failed pull of lever 1 multiplies r by (1−Λ)/(1−λ). If the related variable ρ=log r is introduced, each transition acts by a constant translation on ρ.

The four-dimensional discrete states (a₁, b₁, a₂, b₂) are converted into one-dimensional real states ρ, and the value function is henceforth written as V(ρ).

### Iterative Solution

By standard theory of Markov decision processes, the value function V(ρ) of an optimal strategy satisfies the equation:

V(ρ)=max{V₁,V₂} (2)

here V₁ and V₂ are the natural estimates of the results of pulling lever 1 and lever 2 respectively, namely the following. Let ω=e^{ρ}/(1+\vec{ω})); then:

V₁=ω(Λ(1+V(ρ+c₁))+(1−Λ)V(ρ−c₂))+(1−ω)(λ(1+V(ρ+c₁))+(1−λ)V(ρ−c₂));

V₂=ω(λ(1+V(ρ−c₁))+(1−λ)V(ρ+c₂))+(1−ω)(Λ(1+V(ρ−c₁))+(1−Λ)V(ρ+c₂)), (3)

where the cᵢ are given by:

$${e}^{{c}_{1}} = \frac{Λ}{λ} , {e}^{{c}_{2}} = \frac{1 - λ}{1 - Λ} .$$

Moreover, the process of iteratively replacing every value V(ρ) with the right side of (2) converges to the optimal V from arbitrary bounded input, such as V(ρ)≡0. Therefore, V(ρ) is represented discretely as the piecewise-linear interpolant of its samples at evenly spaced grid points (say multiples of a user-configurable parameter δ>0) in a large interval [−L, L] centered at the origin (L>0 a user-configurable parameter), and repeatedly set every V(ρ) for sampling points p to the right side of (2) until the maximum change in a value during a full iteration is less than a user-configurable parameter ε>0. The result is (approximately) the optimal valuation.

### Extracting the Answer

To compute the information value of an ad site with a conversions, b unconverted chargeable events, and an estimated conversion probability of μ, the ad site's average conversion value may be multiplied by the difference X−μ, where X is the quantity in (3) for the following state of a two armed-bandit game. The game has probability parameters λ=(1−c)μ, and Λ=(1+c)μ, where 0<c<1 is a user-configurable parameter of which, without limitation, c=½ is a reasonable value. The discount factor is near 1; without limitation γ=0.99 is reasonable. The state p corresponds to the four-dimensional discrete state (a, b, 0, 0).

### Bidding System for Ad Services

In another embodiment of the present invention, a bidding system is presented for ad services that define position. An ad service is illustrated schematically in FIG. 2 at 202. According to one facet of this embodiment, the bidding system is designed to roughly optimize revenue given a pre-established expense budget. In general, a user may specify an amount of money to try to spend on an entire ad campaign. The system of one particular embodiment uses a volume model and a position model to calculate for each ad site the cost and revenue expected from a sampling of bidding levels, and a set of bids that efficiently allocate spending among the ad sites is determined by a greedy algorithm.

### Bidding Levels

A user-configurable parameter L specifies the maximum expected expense to be allowed in a campaign in the next reporting period. A user-configurable parameter B specifies the maximum bid allowed for any ad site.

For each ad site, the system may define a finite increasing sequence bᵢ of allowed bids; the remaining task of the system is to choose for each ad site a bid from this sequence. The first element of the sequence is always b₀=0. Unless the ad service defines a minimum bid for the ad site, and that minimum bid is greater than B, the sequence contains the minimum bid (or a user-configurable small constant if a minimum bid is not defined) as the second element b₁, and for each i≧2, bᵢ is taken to be the lesser of B and the product ηbᵢ₋₁, where η>1 is a user-configurable granularity constant. The first occurrence of B is then the second last element of the sequence. In this example, the last element of the sequence is always ∞ (a sentinel; the algorithm will never choose it as the output bid).

### The Greedy Algorithm

At the outset, an estimated expense tally τ is initialized to zero, and a priority queue is maintained which contains one item for each ad site. Each item preferably maintains a next bid, a marginal expense, and a priority value. The next bid is initially b₁. The marginal expense of an item with next bid ∞ is ∞, and the marginal expense of an item with finite next bid bᵢ is the difference:

bᵢ volume(bᵢ)−bᵢ₋₁ volume(bᵢ₋₁),

where volume(b) means the number of chargeable events expected in a reporting period when the ad site has a bid of b in effect. This may be calculated using a volume model and position model. The priority value for an item with next bid ∞ is ∞, and the priority value for an item with next bid bᵢ is the ratio:

$$\frac{{b}_{i} volume ( {b}_{i} ) - {b}_{i - 1} volume ( {b}_{i - 1} )}{revenue ( {b}_{i} ) volume ( {b}_{i} ) - revenue ( {b}_{i - 1} ) volume ( {b}_{i - 1} )} ,$$

where revenue(b) means the expected value generated by a chargeable event on this ad site as computed from the Bayesian value generator. In other words, the priority is the cost per unit value generated, so lower (better) priority corresponds to more efficient revenue generation.

It may be desirable, in certain embodiments, for the bidding algorithm to include the following instructions: repeatedly remove from the priority queue the lowest-priority item whose associated marginal expense is no greater than L−τ; add that marginal expense to τ, then replace that item's bid with the next bid in its sequence; recalculate that item's priority and marginal expense; and reinsert it into the queue. When there are no items whose marginal expense does not exceed L−τ, stop and write out each ad site's current bid.

### Graphing Variants

The system includes code to output samples of revenue, profit, and profit margin at various cost levels, suitable for graphing. For this use, the loop above is run with a high limit, and the current total estimated expense and expected revenue (or profit, or profit margin) are written into the output stream, and the bids themselves are not output at any stage.

### Estimating Average Volume of Chargeable Events Expected for Position

In yet another facet of the inventive subject matter presented herein, a system and method is provided for estimating the average volume of chargeable events received on an ad site for each position in which the ad site appears for a given reporting period. In general, it may be assumed in this facet that the ad service defines position.

In one illustrative application, the calculation may use data on chargeable events and data on impressions, if there exists a concept of impression in the ad service and that concept is distinct from that of the chargeable event. In general, the system fits a certain model to the data obtained from a cost-side reporter and a revenue-side reporter (such as those shown in FIG. 2 at 206 and 208, respectively) by phrasing the problem as a least-squares problem amenable to methods of linear algebra. By way of example, the system breaks down into a global model of the shape of average volume and a procedure for calculating volume estimates for specific ad sites.

### Shape of Model

The volume of chargeable events on an ad site may depend on several factors, including, for example:
1. The position of the ad—an ad may get considerably more clicks in more prominent positions.
2. The ad site itself—some ad sites draw more prospective customers than others.
3. The reporting period—for instance, in many search-engine PPC campaigns, reporting periods are days, and activity is higher on weekdays than on weekends. In the example presented herein, it may be supposed that reporting periods fall into a finite number of classes rpc involved in this dependence. If no such structure is available, it may be assumed that there is only one class, containing all reporting periods.
   To model these dependencies, it may be postulated that if the ad for an ad site site appears consistently in position p, its expected rate of chargeable events per reporting period is of the form:

clicks=α_{rpc}βₛᵢₜₑf(p) (4)

where, as the notation suggests, the factor α_{rpc} depends on the class of the reporting period; the factor βₛᵢₜₑ depends on the ad site site; and the factor f(p) is a function of the position of the ad in that reporting period. After the data for several reporting periods have been received from the campaign giving each ad site's average position and number of chargeable events in each reporting period, the model (4) may fit to a set of data. If a set of ad sites have too little individual data, the estimates of the site-dependent parameters βₛᵢₜₑ may be inaccurate; an acceptable level of accuracy can be expected for the α_{rpc} and f(p), which are not very numerous.

The α factors are easily handled. For example, α_{rpc} may be estimated as the proportion of the total chargeable events in a PPC campaign that occurred during reporting periods in class rpc. If an ad site received c chargeable events in a reporting period of class rpc, it may be said that it received c/α_{rpc} normalized chargeable events in that reporting period. From the model equation (4) presented above, the normalized chargeable events on an ad site should have the average behavior βₛᵢₜₑf(p), which is generally independent of the reporting period; so numbers of normalized chargeable events on different reporting periods can be compared pari passu.

Continuing with the present example, the crux of the problem may be to disentangle the universal position-dependence function f from the site-dependence factors βₛᵢₜₑ. The individual βₛᵢₜₑ cannot be estimated well enough to divide them out from the data directly as illustrated above with respect to α_{rpc}. It is noted, however, if there are two perfectly accurate readings of average normalized chargeable events for an ad site, one for position p₁ and the other for position p₂, then the ratio between the two averages would be:

$$\frac{{β}_{site} f ( {p}_{1} )}{{β}_{site} f ( {p}_{2} )} = \frac{f ( {p}_{1} )}{f ( {p}_{2} )} ,$$

which involves f only. Knowledge of the ratios f(p₁)/f(p₂) determines f up to a scaling constant. Then the primary uncertainty in the average volume is the site-dependence factors βₛᵢₜₑ, which are discussed below.

### Solving the Fitting Problem

Continuing with the above presented example, the next step is to determine the function f from the data. As previously noted, the ratios f(p₁)/f(p₂) may be computed directly if there existed copious data and the model was perfectly true. In the real world, of course, the model may not be perfect, and there is no ad site with perfectly accurate measured averages of normalized chargeable events. Rather, it is common to have many ad sites with approximate measurements whose errors differ. Therefore, the calculation of f may be phrased as a fitting problem, as described hereinbelow.

In one representative embodiment, for each pair of given positions p₁ and p₂, data from all ad sites that have appeared in positions p₁ and p₂ for at least one reporting period each is aggregated, producing an estimate of f(p₁)/f(p₂); a suitable least-squares fitting problem involving these ratios is then solved. More explicitly, given positions p₁ and p₂, with 1≦p₁≦p₂≦10, let S_{p1,p2} denote the set of ad sites that have appeared for at least one reporting period in position p₁ and also for at least one reporting period in position p₂. Let n_{p1,p2}, denote the number of ad sites in S_{p1,p2}. The quantity may then be calculated as follows:

$${c}_{p 1 , p 2} = \frac{{\sum }_{{ }_{site} ε {S}_{p 1 , p 2}} ( \begin{matrix}average normalized chargeable \\ events on site on periods \\ when it had position {p}_{1}\end{matrix} )}{{\sum }_{{ }_{site} ε {S}_{p 1 , p 2}} ( \begin{matrix}average normalized chargeable \\ events on site on periods \\ when it had position {p}_{2}\end{matrix} )} .$$

This is a reasonable estimator of the ratio f(p₁)/f(p₂), for if the estimated averages of normalized chargeable events in the fraction above were exact values consistent with the model (4), this fraction would equal:

$$\frac{{\sum }_{{ }_{site} ε {S}_{p 1 , p 2}} {β}_{site} f ( {p}_{1} )}{{\sum }_{{ }_{site} ε {S}_{p 1 , p 2}} {β}_{site} f ( {p}_{2} )} ,$$

in which the constants f(p₁) and f(p₂) can be factored out of the sums, and then the sum of βₛᵢₜₑ, can be canceled.

The f(p) may now be chosen so that the ratios match the ratios estimated from the data as nearly as possible. By way of example, the f(p) may be chosen to minimize the quadratic form:

$${\sum }_{1 \leq {p}_{1} < {p}_{2} \leq 10} {{n}_{p 1 , p 2} ( f ( {p}_{1} ) - {c}_{p 1 , p 2} f ( {p}_{2} ) )}^{2}$$

subject to any convenient fixed normalization condition on f (this exemplary implementation somewhat arbitrarily takes f(5)=1). This minimization problem is solved by least-squares methods from linear algebra. The weights of n_{p1,p2} grant greater influence to estimates arising from larger data sets, which makes sense because estimates from more data tend to be more reliable.

### Computing Results for Individual Ad Sites

Continuing with the above example, once good measurements of α_{rpc} and f(p) have been procured, only βₛᵢₜₑ need be measured to compute the average volume on an ad site site appearing in a particular position on a particular reporting period. If a site draws heavy traffic, the quotients:

$$\frac{chargeable events on site in the reporting period}{{α}_{rpc} f ( p )} \qquad ( 5 )$$

are estimators of βₛᵢₜₑ, and the average of this measurement over several reporting periods should give a serviceable value of βₛᵢₜₑ. If, however, a site is not heavily trafficked, this procedure may give inaccurate answers, particularly spurious zero values of βₛᵢₜₑ when site happens not to have yet experienced a chargeable event. These zero estimates are potentially dangerous. An algorithm might completely ignore these sites because they appear to have no revenue potential on account of the zero volume. In the other direction, an algorithm may attempt to spend a budgeted amount of money might bid up an enormous number of sites with estimated β=0, erroneously assuming it costs no money to do so because those sites will incur no chargeable events, whereas in fact some non-negligible proportion may indeed be clicked, adding up to an unwarranted expenditure for the reporting period.

There may not be a complete solution to the aforementioned problem, but there are countermeasures available that are proposed below. First, it may be specified that the estimator of βₛᵢₜₑ in (5) over a reporting period will always be taken to be at least a given user-specified nonzero (and probably small) quantity. This limits the problems mentioned above even when site has never even had an advertisement shown. Secondly, if the ad service has a notion of impression that is not the same as a chargeable event, there will be more impressions than chargeable events, and a number of chargeable events equal to zero may be replaced with a small constant fraction of the impressions in the same reporting period.

Calculating Estimate of Relationship between Position and Bid

Turning now to another embodiment, we consider a fixed single ad site in an ad service that defines position, and describe one manner of computing for each position p a bid b(p) that is likely to put the fixed ad site's ad in position p. It is desirable to deduce b from available records of a bid(s) and the average position of an ad(s) in each reporting period.
The ad site may not have appeared in each of the positions, so it is possible to infer reasonable bids for unattested positions from bids that resulted in other positions.
Real-world data on bids and positions fluctuate significantly because of competitors' changing behavior and ad services' own algorithms for choosing ads to display.
The world will change over time, so it may be desirable to give old data less weight than recent data.

In one embodiment of the present invention, a system for calculating an estimate of the relationship between position and bid for ad sites on an ad service that defines position is presented. In one facet, the system involves a weighted central statistic (see below) that may be realized arbitrarily. In this embodiment, the system computes for each ad site and each ad position a suitable weighted central statistic of weighted points determined by each reporting period's bid and position for that ad site. The system converts the function associating each position to its weighted central statistic into a similar monotonic function, which it returns. In an alternative embodiment, a similar system is presented, differing only in specifying the weighted central statistic. In regard to the former, the system may be configured to look up average position and bid information from the cost-side reporter for each available reporting period. For each position p, this information is used to construct a sequence of weighted estimates (xᵢ, wᵢ) of b(p). The raw value of b(p) is set to a weighted central statistic of the weighted points (xᵢ, wᵢ) (e.g., to a function of the weighted points whose value is in the middle of the values xᵢ and whose computation gives more weight to points xᵢ with larger weights wᵢ). In addition, the value b(p) may be associated with a weight w(p) that equals the sum of the wᵢ in the calculation yielding b(p). This function b(p), however, may not be decreasing in p—i.e., it may happen that b(p₁)<b(p₂) even though p₁<p₂. As such, the raw function b(p) is run with its weights w(p) through a monotonization procedure to make it decreasing in p with as little modification as possible.

### Inputs to Central Statistic

In one aspect of the present concepts, a procedure is specified for computing the central statistic given an input sequence of weighted points (xᵢ, wᵢ), and specifying the (xᵢ, wᵢ) that will be supplied to this procedure in computing the raw (premonotonization) value of b(p) for a given ad site.

In one example, each reporting period for which information is available about the given ad site generates exactly one point (xᵢ, wᵢ) in a way that depends on three user-configurable parameters i, λ, and o. The “inflation” parameter i>1 is the assumed value of the ratio b(p−1)/b(p) in the absence of other information, i.e., the factor by which it may be expected to have to raise ones bid to end up in the next higher position. The “locality” parameter λ<1 is intended to specify the strength of the influence of data for one position on the result computed for a different position. The “obsolescence” parameter o<1 specifies the relative significance of older data in comparison with newer data.

For a reporting period rp, let Aᵣₚ be the number of existing reporting periods later than rp; let Bᵣₚ be the bid posted for the given ad site during rp; let Pᵣₚ be the average position of the ad during rp. Then rp contributes to the calculation of b(p) a weighted point (x, w), where

x=Bᵣₚi^{P}^{ᵣₚ}^{-p} and w=λ^{|P}^{ᵣₚ}^{-p|}o^{A}^{ᵣₚ}.

### Monotonization

In certain embodiments, given a function b(p) of position that may not be decreasing in p and corresponding weights w(p)>0, a procedure may be provided for modifying b as slightly as possible to obtain a similar but decreasing function of position, preferring to move points with smaller weights more aggressively.

The weighted points (b(p), w(p)) may be considered as objects moving in time in one dimension and occasionally changing masses. The value b(p)(t) is the location coordinate, and w(p)(t) is the mass, at time t. The objects move as follows:
The location b(p)(t) is continuous in time and almost everywhere once differentiable with derivative:

$$\frac{\partial }{\partial t} b ( p ) ( t ) = - {\sum }_{{p}^{′} < p and b ( {p}^{′} ) ( t ) < b ( p ) ( t )} \sqrt{\frac{w ( {p}^{′} ) ( t )}{w ( p ) ( t )} +} {\sum }_{p < {p}^{′} and b ( p ) ( t ) < b ( {p}^{′} ) ( t )} \sqrt{\frac{w ( {p}^{′} ) ( t )}{w ( p ) ( t )}} . \qquad ( 6 )$$

Intuitively, the pairs of points whose values are in the wrong order push each other in the right direction at a constant speed that increases with the weight of the pushing point and decreases with the weight of the pushed point. The square roots cause the weighted average of the points to be preserved by the pushing.
For any time t and position p, let [p′, p″] be the largest interval of positions containing p and such that every position p′″ in the interval has b(p′″)(t)=b(p)(t). Then w(p)(t) equals the (unweighted) average of the original values b(p′″) over all p′″ in the interval. Intuitively, this means that whenever several points for adjacent positions have the same value, they must thenceforth be treated as having the same weight so that they shall move in unison ever after (i.e., their location coordinates are equal at every later time also).
   The output from the algorithm may be designated as the limiting values b(p)≡b(p)(+∞), which can be shown to exist and be decreasing in p.

In exact real arithmetic, the method of one embodiment includes the following: repeatedly until b(p) is monotonic, compute the time δt until the next moment at which two points collide (a trivial algebra computation because the locations vary linearly between collisions); compute the locations at that time by equation (6), and replace each b(p) with the corresponding evolved location; and for every group of contiguous positions with the same location, set the weight of each point in the group to the average of the current weights of those points. In floating-point arithmetic, it is desirable to avoid delaying endlessly when two points have very close but unequal locations; it may be considered sufficient to make a necessary refinement, such as, after replacing the location values after a collision between positions p₁ and p₂, but before modifying weights, calculate the average μ of the new values b(p₁) and b(p₂) (without roundoff they would be the same), and assign μ as the new location of every position p between p₁ and p₂ for which the current value of b(p) differs from μ by a small relative error, say 50 times a unit in the last place of max{b(p), μ}. This refinement completes the system. It is contemplated, in certain embodiments, that the weighted central statistic is the weighted median, or more generally the weighted q-quantile. That is, if the weighted data are (xᵢ, wᵢ), let σ denote a permutation of the indices such that the sequence x_{σ(i)} is increasing; then the weighted central statistic is x_{σ(i)} for the least i such that Σ_{j≦i}w_{σ(j)}≧½, or more generally Σ_{j≦i}w_{σ(j)}≧q. In addition, or as an alternative thereto, the weighted central statistic may be the weighted mean. That is, if the weighted data are (xᵢ, wᵢ), then the weighted central statistic is Σwᵢxᵢ/Σwᵢ.

### Nested Groups

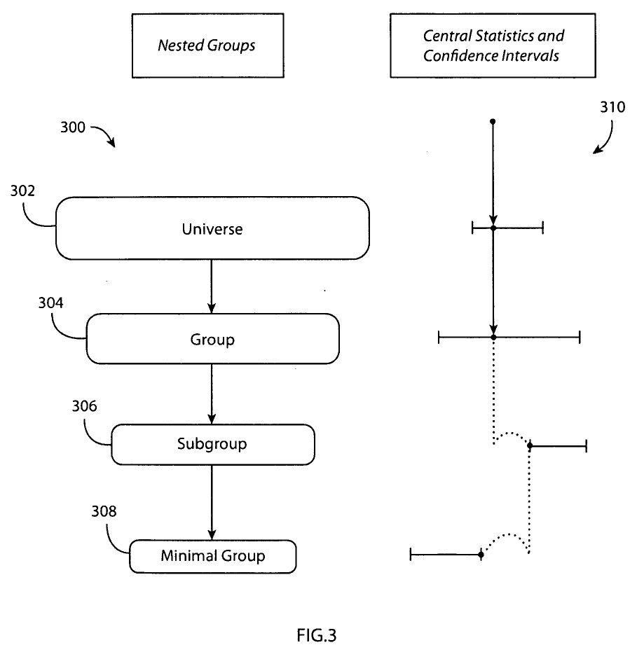

Referring now to FIG. 3, a flow chart is presented diagrammatically illustrating a chain of nested groups 300 and corresponding ranges of plausible central statistics 310 associated with each group. In calculating an estimate of the relationship between position and bid for an ad site, the system may be adapted to take as input a set of properly nested groups of ad sites (implicitly including the group of all ad sites in the campaign), and produce for each group G a probability distribution φ_{G}(μ) to be used as the prior distribution of conversion probability for ad sites that lie in G and in no smaller group. A set of groups of ad sites may be said to be properly nested if whenever two of the groups intersect, one of the groups completely contains the other. By way of example, and not limitation, the system produces a central statistic for each of those groups by structural induction over the tree, as described hereinabove. This exemplary system communicates with the cost-side and revenue-side reporters to determine totals of chargeable events and conversions for each ad site.

### Plausibility of Probability Distribution for Group

Referring to FIG. 3, given a group G and a distribution φ purported to represent the distribution of conversion probabilities of ad sites in G, it is desirable to decide how plausible that assertion is in light of the totals of chargeable events and conversions that have accrued on each ad site in G.

Let aᵢ be the number of conversions of ad site i, and let nᵢ=aᵢ+bᵢ be the number of chargeable events on ad site i. Let A denote the sum of the aᵢ. The plausibility of a distribution φ with respect to this data may be defined to be the smaller of the following quantities:
The probability that the total number of conversions obtained when ad sites with conversion probabilities drawn from the distribution φ receive nᵢ chargeable events respectively will be less than or equal to A.
The probability that that total number of conversions will be greater than or equal to A.

Certain applications may merely require the plausibility be determined to within a very modest absolute precision—e.g., only about 10⁻². This makes Monte Carlo simulation the method of choice. A naïve but serviceable form of this algorithm includes the following:
1. For each distinct value of nᵢ, precompute for each 0≦t≦nᵢ the probability that exactly t conversions result from nᵢ clicks on a keyword whose conversion probability is drawn from φ. This value is:

$$p ( {n}_{i} , t ) := ( \begin{matrix}{n}_{i} \\ t\end{matrix} ) {\int }_{0}^{1} {{μ}^{t} ( 1 - μ )}^{{n}_{i} - t} φ ( μ ) d μ$$

In the useful special case where φ is a binomial distribution, this integral is easily evaluable in terms of gamma functions. In any case, the numbers p(nᵢ, t) define a probability distribution supported on the integers t with 0≦t≦nᵢ by the rule that p(nᵢ, t) is the probability of t. This distribution may be called the conversion-total distribution associated to nᵢ.
2 For a user-configurable constant N on the order of 10,000, record N trial results. A trial result is the sum over i of a sample from the conversion-total distribution of nᵢ. A sample is taken as follows: compute a uniform deviate 0≦r≦1; then the sample is the least integer 0≦t≦nᵢ such that Σ_{0≦r′≦t}p(nᵢ, t′)≧r.
   For large inputs, this naïve method may be accelerated substantially by the following devices:
Before running the simulations, reduce the number of distributions by repeatedly replacing pairs of distributions with their convolution until there are no more convolutions to perform whose resulting size does not exceed a user-configurable bound. The convolutions may be done naïvely or by Fourier methods.
The naïve method adds up one sample from each distribution to obtain the total conversions in one trial, then repeats this to obtain the required number of trial results. Instead, all the trial conversion counts can be maintained simultaneously and looped once over the distributions. At each distribution, the trial samples may be taken to be the r+i/N quantiles of the distribution for 0≦i<N, where 0≦r<1/N is a uniform deviate. Thereafter, permute the trial samples before proceeding to the next distribution. Without the permutation step, the procedure would add low results to low results and high results to high results, obtaining a final answer that may be skewed toward extremes; but with a suitable permutation the result is sufficiently accurate in practice. An index permutation of the form i [symbol] (i xor α)*β mod N with suitable constants α and β is fast and sufficiently mixing for the purpose.
   It may be said that a distribution φ is plausible for a given group G if the plausibility of φ for G is at least θ, where 0<θ<½ is a user-configurable threshold parameter.

### Use of One-Parameter Families

It may be necessary to search for distributions φ in some space and compute compromises between two such distributions. These operations are easiest to perform if a one-parameter family of distributions is chosen, e.g., a mapping from a central statistic 0≦v≦1 to a distribution φᵥ, and manipulate the real number v instead. It may be desirable that the distributions φᵥ have similar shapes, but be concentrated near v in some sense, e.g., that the mean of φᵥ is v.

In principle, any one-parameter family v [symbol] φᵥ can be used. A useful case is the mapping of v to a binomial distribution φ(μ)=const·μ^{a}(1−μ)^{b}, where the parameters a and b may be determined by the rules:

a=α⁻¹v(1+ρ⁻¹)−(1+v) and b=(1+a)(v⁻¹−1)−1,

where ρ=min{v, 1−v} and 0<α<1 is a user-configurable constant.

### Structural Induction on Tree

To each group G, such as that indicated at 304 in FIG. 3, it may be necessary to associate a central statistic v_{G}, and then the central statistic of an ad site will be v_{G0}, where G₀ is the smallest group containing that ad site. The values v_{G} may be defined recursively as follows: if G is smaller than a “universe”, such as 302 of FIG. 3, then it has a parent G′. It may then be assumed by induction that v_{G′} is already defined. Then, if v_{G′} is a plausible statistic for G, v_{G}=v_{G′}; otherwise v_{G} may be taken to be the value nearest to v_{G′} that is plausible for G, which is found, for example, by binary search in the interval of central-statistic values. In the base case where G is the universe, this procedure may be applied with v_{G′} equal to a user-configurable constant representing a guess of the average conversion probability expected for ad sites in the campaign. FIG. 3 of the drawings illustrates this procedure.

This definition allows the behavior of a larger group to trump the behavior of the smaller group when the latter is statistically insignificant, whereas the smaller group's behavior will mostly determine the answer if it is statistically significant. By way of example, the behavior of Universe 302 would trump the behavior group 304. In contrast, the behavior of minimal group 308 may plausibly trump the behavior of subgroup 306 if it is statistically significant.

Turning to FIG. 3, the error bars under the central statistics 310 on the right side of FIG. 3 represent the range of plausible central statistics for the corresponding groups 300 on the left side of FIG. 3. The thick dots on the right side of FIG. 3 represent the computed central statistic on a horizontal axis. In the illustrated example, a user's guess of the average conversion probability is passed down unchanged to the Universe 302 and then to Group 304, being within the plausible range for those groups. However, in passing from Group 304 to Subgroup 306, this value is implausible for Subgroup 306, so it is replaced with the nearer endpoint of the plausible range, here the left endpoint. This value is in turn out of range for Minimal Group 308, where this time the right endpoint of the plausible range is the nearer. The conversion probability of any ad site contained in Minimal Group 308 and in no smaller group is computed with respect to this last value of the central statistic.

In the embodiment described in the section below, the system takes as input a set of groups of ad sites that need not be properly nested (e.g., as defined above), and produces for each ad site a central statistic to be used in computing its conversion probability. In one particular approach, the central statistic is generated by traversal of the hypercube lattice of repeated intersections of groups containing that ad site, as described below. In the example discussed below, the system freely uses data from the cost-side and revenue-side reporters in the calculation.

Similar to the examples discussed above, this particular exemplary embodiment may seek to assign a plausible central statistic to each ad site by an inductive procedure on a suitable set or sets of ad sites containing the ad site in question. In certain embodiments, the use of a one-parameter family of distributions, as well as the notion of plausibility of a central statistic on a set of ad sites given the observed numbers of conversions and chargeable events for each discussed above remain unchanged.

In the method of this embodiment, however, is may be desirable to not globally assign central statistics to groups, and then decree that each ad site uses the distribution associated to a particular group. Rather, for each ad site separately, it is desirable to construct a hypercube graph involving the groups containing that ad site, perform a hierarchical assignment of central statistics for the nodes of that graph, and obtain a central statistic for that ad site, after which it is desirable to discard the graph and its associated central statistics and move on to the next ad site.

### Hypercube and Traversal of a Hypercube

For each ad site, a hypercube graph may be defined as follows. If the ad site is contained in n groups G₀, G₁, . . . , Gₙ₋₁, the hypercube graph has 2ⁿ nodes labeled by the length-n bit vectors. In general, there is a directed edge \vec{v}→\vec{v}′ if and only if \vec{v}′ is obtained from \vec{v} by changing a single 0 bit to a 1 bit. This is a directed graph but no longer a tree in general. Each node \vec{v} may include an associated set of ad site S_{\vec{v}} given by the intersection of Gᵢ over all i such that bit i is set in \vec{v}, where the bit positions are numbered 0 through n−1; the special case So means the set of all ad sites. It is possible that S_{\vec{v}}=S_{\vec{v}′} even though \vec{v}≠\vec{v}′.

At each node \vec{v}, a central statistic v_{\vec{v}} and a weight w_{\vec{v}} may be defined by the following recursive procedure. At the zero node, the weight is 1 and the central statistic v₀ is a user-configurable constant representing a guess of the average conversion probability to be expected in the campaign. At a node \vec{v}≠0, compute the weighted average

$$v = \frac{{\sum }_{{\vec{v}}^{′}} {w}_{{\vec{v}}^{′}} {v}_{{\vec{v}}^{′}}}{{\sum }_{{\vec{v}}^{′}} {w}_{{\vec{v}}^{′}}} ,$$

where the sums extend over all parents \vec{v}′ of \vec{v}. Then the central statistic ν_{\vec{v}} is the result of clamping v to a plausible value for the set of ad sites S_{\vec{v}}b by the same method presented above, and the weight w_{\vec{v}} is ε+|v_{\vec{v}}−v|, where ε is a small constant, say 10⁻⁶.

The ad site's central statistic may now be defined as v_{\vec{v1}}, where the subscript \vec{v1}=11 . . . 1 is the vector with all bits set.

### Automatic Group Generation

On certain ad services, ad sites are text strings, as is true for instance in typical search-engine PPC campaigns; it is common, therefore, to speak of “strings” rather than of “ad sites”. In certain aspects of the abovementioned concepts, the system generates a set of groups of strings from an input set of strings for which no additional structure is provided. Moreover, the system in some exemplary embodiments takes as input an unstructured set of strings (i.e., ad sites), and produces as output a set of groups of those strings such that for each group all strings contain a common substring (e.g., there is a substring that every string in that group contains) that is likely to be a word, desirably a word of reasonable length.

The systems of selected embodiments read in all the input strings, and compile a list of every substring occurring in any input string as a word. For example, in some input strings, the substring occurs bracketed by non-alphabetic characters or edges of the input string, as does cat in cat burglar, cat-o'-nine-tails, and feral cat colony, but not in indicate. Next, the system counts for each such substring the number of input strings that contain it as a substring (not necessarily as a word, so, for example, cat is contained in indicate in this sense). Finally, for each such substring for which this count exceeds a user-configurable lower limit (probably between about 5 and 100 depending on the size and organization of the campaign), the system writes out a group containing exactly those input strings which contain that substring.

In other embodiments, the system takes as input an unstructured set of strings (i.e., strings for which no additional structure is provided), and produces as output a set of groups of those strings such that in each group all strings are related in that each pair of them has short edit distance between them.

The edit distance (or Levenshtein distance) between two strings s and s′ may be defined as the least length of a sequence of edits that converts s into s′. Here, an “edit” on a string may include one of the following three transformations:
1. “Insertion” of any single character at any one point in the string, e.g., cat cast.
2. “Substitution” of any single character for any single character in the string, e.g., cast→cart.
3. “Deletion” of any single character from the string, e.g., cart→car.
   For example, the edit distance between the strings cattery and catering is 4, one of the shortest edit sequences being:

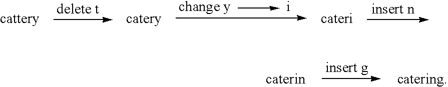

When the system computes the edit distance of a pair of strings, a dynamic-programming algorithm may be employed, such as that discovered by V. I. Levenshtein and described in “Binary codes capable of correcting deletions, insertions and reversals”, Doklady Akademii Nauk SSSR 163 (4) 1965, 845-848; Soviet Physics Doklady 10 (8) 1966, 707-710, which is incorporated herein by reference in its entirety.

First, the undirected graph G is constructed whose vertices are the input strings and whose edges join exactly those pairs of distinct strings whose edit distance does not exceed δ, where δ is a user-defined positive integer, probably small (e.g., δ=3). It is generally straightforward, though sometimes slow for large input sets, to iterate through all pairs of distinct strings, computing each pair's edit distance and adding the appropriate edge to the graph when the result is at most δ.

Once the graph is constructed, it may be necessary to break the graph into pieces in order to produce a set of groups of input strings. The breaking process is preferably regulated by a user-configurable depth parameter ζ, a small positive integer (desirably not greater than 3). For each component H of G, the vertices of H are sorted in descending order of their ζ-path ranks, where the ζ-path rank of a vertex v is the number of paths of ζ edges beginning at v, then iterate through the vertices of H in that order. For each such vertex v, a breadth-first search may be used to compute the set of vertices of H that can be joined to v by a path of at most ζ vertices (which includes v itself because of the zero-length path at v). This set of vertices may be output as a group, and then strike out all its members from the list of vertices remaining in the inner loop (so that they will not be the v of any later iteration of this loop) before continuing to the next iteration. This method is structured to prefer to create large groups and to avoid creating unnecessarily many groups containing any particular string.

### Preclassification by Bit Vectors

Generating a set of groups of ad sites that are related by having small Levenshtein distances between them may be performed more efficiently for large inputs. For instance, the system may use a preclassification by bit vectors to speed up the computation substantially on large input sets. The primary part of the system that may be changed is the construction of the graph of pairs of strings with small edit distance. The naïve treatment, an iteration through all pairs of strings, may require about N²/2 edit-distance computations for an input set of N substrings, a fairly heavy burden for a thorough long-tail campaign, where quite likely N≈10⁵ or even 10⁶. To improve the complexity, it may be desirable to avoid having to look at most of those pairs of strings at all. This may be accomplished by first partitioning the set of input strings into a number of equivalence classes Sᵢ with a property of the following shape: for each Sᵢ, there are relatively few Sⱼ adjacent to Sᵢ—i.e., there are few Sⱼ for which there might exist an element of Sᵢ and an element of Sⱼ whose edit distance is at most δ. The preprocessing time will be negligible compared to the time to run the naïve edit-distance computation: the preprocessing iterates once through individual input strings rather than pairs of strings, whence it has linear rather than quadratic complexity. After preprocessing, instead of iterating over pairs of distinct strings, the system can iterate over pairs of (not necessarily distinct) sets (Sᵢ, Sⱼ), and for each such pair compute the edit distances between pairs (sᵢ, sⱼ) for sᵢεSᵢ and sⱼεSⱼ and add edges to the graph as appropriate. This procedure, like the naïve procedure, considers each pair of input strings at most once, but unlike the naïve procedure, the new procedure does not spend any time considering pairs (s, s′) for which the equivalence classes of s and s′ are not adjacent.

To each string s there corresponds a 27-bit tally vector defined as follows. For example, let a₀ be the parity bit (i.e., 0 for an even number and 1 for an odd number) of the number of capital or lowercase a's in s; let a₁ be the parity bit of the number of b's in s, and so on; and let a₂₆ be the parity bit of the number of nonalphabetic characters in s. If s′ is another string with corresponding tallies a′ᵢ, and if the edit distance between s and s′ is at most δ, then:

$${\sum }_{0 \leq i \leq 26} \vert {a}_{i} - {a}_{i}^{′} \vert \leq 2 δ ,$$

for each edit can change at most two tally bits (two if a substitution, one otherwise). Thus, whenever the bit-vectors for two strings differ in strictly more than 2δ positions, those two strings must have an edit distance exceeding δ, and it may not be necessary to consider that pair of strings at all. This suggests indexing the Sᵢ by 27-bit vectors, each set containing the strings with the given value of the tally vector.

But 2²⁷ sets may be too many; most will be empty or singleton for typical inputs. Therefore, it may be desirable to define a parity trace to be a function that maps a 27-bit vector to a d-bit vector, where the dimension d is any integer between 1 and 27 inclusive, by performing a sequence of 27-d operations of the following form: remove any two bits from the vector (shortening the vector by two bits), and append the exclusive-or of the removed bits to the least-significant end of the vector (lengthening the vector by one bit, so the net change in dimension is a decrease of one bit). It remains true for any parity trace that two strings whose parity traces differ in more than 2δ bits have edit distance greater than δ.

Given any parity trace, the edit-distance graph may be constructed as follows: the input strings are grouped into sets Sᵢ by the values assigned to the strings by the parity trace. The adjacent sets Sⱼ are those whose parity-trace value differs from that of Sᵢ in at most 2δ bits. For each nonempty Sᵢ, for each Sⱼ adjacent to Sᵢ, it is desirable to compute the edit distance of every pair (sᵢ, sⱼ) of strings sᵢεSᵢ and sⱼεSⱼ, and add edges to the graph as appropriate.

The complexity of the algorithm for a given parity trace may be estimated by:

$$\# \{ i \text{:} \vert {S}_{i} \vert \neq 0 \} {\sum }_{0 \leq j \leq 2 δ} ( \begin{matrix}d \\ j\end{matrix} ) + \sum \vert {S}_{i} \vert \vert {S}_{j} \vert ,$$

where the second sum is extended over all adjacent pairs (Sᵢ, Sⱼ). The second term in this expression represents the cost of computing the edit distances for the pairs of strings that cannot be ruled out quickly; the first term reflects that every nonempty Sᵢ is processed in the outer loop even if every adjacent Sⱼ is empty. This complexity estimate can be quickly computed for any given parity trace: simply tally the sizes of the Sᵢ in a simple loop over the input strings and directly evaluate the formula displayed above.

To complete the algorithm, all that may be necessary is to say how to choose a reasonably efficient parity trace. It may be sufficient to estimate the complexity of several dozen randomly chosen parity traces of middling dimensions, and then run the computation using the parity trace with the best complexity estimate among those. Without limitation, one practical choice of the sampling procedure is to take five random parity traces from each of the dimensions 14≦d≦22, where a random parity trace of dimension d is obtained by choosing uniformly at random 27-d disjoint pairs of positions in the raw 27-bit vector and coalescing each such pair of bits separately.

### Bid Generator as Postprocessor

In certain embodiments, a bid generator may act as a postprocessor, identified as an “Optional Postprocessing Bid Generator” 218 in FIG. 2, on the output of another given bid generator, which latter is called the inherited bid generator below.

The system of these embodiments may be designed for efficiency in campaigns characterized by occasional ad sites with very high conversion rates scattered throughout a background of ad sites with modest or bad conversion rates. The system discussed below is designed to ferret out some of the “diamonds in the rough” as fast as possible, while also avoiding unnecessarily wasting money on ad sites with terrible conversion rates. The central idea is to bid high in each reporting period on some ad sites with few chargeable events, then lower the bids on the sites that do not generate a conversion in that reporting period. This process is repeated each reporting period with a new set of sparsely trafficked ad sites.

The process depends on two user-configurable positive real parameters B and L with units of money. The bidding level B is the level to which bids will be raised to search for strong ad sites. The budget L is the amount of estimated additional spending allowed as a consequence of these raised bids.

The first transformation on the bids from the inherited bid generator is to set the bid on any unconverted ad site to zero. Some of these bids will be raised to nonzero values in a later step, but the baseline treatment of ad sites that have not generated revenue is not to continue to risk good money on them.

In accordance with the present example, to decide which ad sites to bid up, the system will first calculate a priority value for each ad site, so that ad sites with lower priority values will be considered first for bidding up. For a given ad site, let c be the number of conversions and e the number of chargeable events for that ad site, and compute the linear combination pc*+qe, where p<0 and q>0 are user-defined scaling parameters, and c* denotes the lesser of c and a user-defined limit, presumably a small integer such as 3. The ad site's priority is then the sum of this quantity and a small random number. This means that ad sites that incur chargeable events without converting will be set aside in favor of less tested ad sites, which ad sites that convert in their first few clicks will be bid up for a long time in the hope that they are strong, which is substantially more likely after an early conversion. But after a few conversions, further conversions stop increasing the priority, so that after much data is available on an ad site, the exploration mechanism will no longer meddle with it, allowing the inherited bidding system to make precise and unimpeded judgments on its performance. The randomization is to break many-way ties, preventing the algorithm from choosing a non-representative sample of a large set of equally untested keywords.

Finally, to determine the output bids, the system will sort the ad sites in order of their priorities, initialize an estimated expense tally τ to zero, and perform the following operations for each ad site: if the ad site's bid b is already at least B, output b unchanged; otherwise, compute the estimated volume v of chargeable events expected on the ad site in the next reporting period if the ad appears in best position, and let η=v(B−b) be the expected additional expense from increasing the bid on this ad site to B; if τ+η≦L, then add η to τ and output the bid B; otherwise, leave τ unchanged and output the bid b unchanged.

### Alternative Embodiments

Presented hereinbelow are an array of alternative embodiments and variations that fall within the scope and spirit of the present invention. The variants discussed hereinafter are not intended to represent every embodiment, or every aspect, of the present invention, and should therefore not be construed as limitations. Further, the following variants and embodiments may be used in any combination or subcombination not logically prohibited. By way of example, the term “system” in the following paragraphs may include any of the combinations of elements in the appended claims. Moreover, the following variants are similarly applicable to any of the method embodiments of the present invention.

The bid generator may be configured to output for each ad site on an ad service the value computed by the Bayesian value generator, multiplied by a user-configurable constant parameter. This constant may be taken somewhat greater than 1 to quickly study the performance of various ad sites early in a campaign, or modestly less than 1 to make a profit later in the campaign.

As noted above, the systems and methods of the present concepts may be adapted to use a volume model and a position model to calculate for each ad site the cost and revenue expected from a sampling of bidding levels, and a set of bids that efficiently allocate spending among the ad sites is determined by a greedy algorithm. The bid generator may configured to output the values computed by the greedy-allocation bid generator.

The conversion-value estimator may configured to output the following value uniformly for every ad site: the average revenue on a conversion, extending the average over all conversions observed in the campaign as well as the one or more additional values received as input or user-configurable parameters.

The information-value estimator may be configured to output the value of zero uniformly for every ad site.

As noted above, the systems and methods of the present concepts may be adapted to calculate an information value for an ad site based on its totals of chargeable events and conversions by embedding this valuation problem in a Markov decision process whose optimal valuation can be found by an efficient one-dimensional iterative process. The information-value estimator may be configured to output the values computed by the system.

The conversion-value estimator may be configured to receive an input signal bearing data defining a partition of all ad sites into one or more equivalence classes. For each ad site whose equivalence class contains at least a minimum number of conversions given as a user-configurable parameter, the conversion-value estimator may be configured to output the following value for that ad site: the average revenue on a conversion, extending the average over all conversions observed for ad sites within that ad site's equivalence class. For each other ad site, the conversion-value estimator may be configured to output the following value for that ad site: the average revenue on a conversion, extending the average over all conversions observed in the campaign as well as the one or more additional values received as input or user-configurable parameters.

The conversion-probability estimator may be configured to define the statistic S(ψ) in the definition of the Bayesian value generator as the mean of the distribution ψ.

The conversion-probability estimator may be configured to define the statistic S(ψ) in the definition of the Bayesian value generator as the q-quantile of the distribution ψ, where 0<q<1 is a user-configurable parameter.

In addition to the above embodiments and variations, the system may further comprise a bid uploader configured to receive the signal output from the bid generator to transmit the calculated bids to the ad service.

The conversion-probability estimator may be configured to define the statistic S(ψ) in the definition of the Bayesian value generator as the mean of the distribution ψ.

The conversion-probability estimator may be even further configured to use one prior distribution φ uniformly for all ad sites, and that φ is a binomial distribution whose parameters are user-configurable.

In addition to the above-disclosed facets, the conversion-probability estimator may be further configured to receive as an input signal or as user-configurable parameters a prior distribution φ that is piecewise linear and to use that φ uniformly for all ad sites.

As noted above, the systems and methods of the present concepts may be adapted to fit a model function to data on the ad sites' totals of chargeable events and conversions by optimizing the logarithm of a maximum likelihood estimator through a variant of a simulated-annealing simplex method, modified to handle inequality constraints correctly. The conversion-probability estimator may be operatively connected to the cost-side reporter and the revenue-side reporter to receive input signals therefrom. In this example, the conversion-probability estimator is further configured to calculate a piecewise-linear prior distribution φ by fitting a piecewise-linear model to the ad sites' totals of chargeable events and conversions, and to use that φ uniformly for all ad sites.

The conversion-probability estimator may be further configured to define the statistic S(ψ) in the definition of the Bayesian value generator as the mean of the distribution ψ.

The conversion-probability estimator may also be configured to define the statistic S(ψ) in the definition of the Bayesian value generator as the q-quantile of the distribution ψ, where 0<q<1 is a user-configurable parameter.

In addition to the above permutations, the conversion-probability estimator may be configured to receive input signals from the cost-side reporter and the revenue-side reporter, as well as an input signal describing several groups of ad sites to be suspected of having similar average performance. In an instance where the system takes as input a tree of properly nested groups of ad sites and produces a central statistic for each of those groups by structural induction over the tree, the groups may be required to nest properly in the sense that if two groups intersect, then one of them completely contains the other. In this embodiment, the conversion-probability estimator may then be further configured to compute a central statistic for each group, and choose for each ad site the prior distribution , in a one-parameter family of models that is associated to the central statistic computed for the smallest group containing that ad site.

In another alternative embodiment, the conversion-probability estimator is configured to receive input signals from the cost-side and revenue-side reporters, as well as an input signal describing several groups of ad sites to be suspected of having similar average performance. The groups are not required to nest properly. That is, as described above, the system may be adapted to take as input a set of groups that may or may not be properly nested. In this regard, the system produces a central statistic for each ad site by traversal of the hypercube lattice of repeated intersections of groups containing that ad site. The conversion-probability estimator is further configured to compute a central statistic for each group, and choose for each ad site the prior distribution φ in a one-parameter family of models that is associated to the central statistic computed for the smallest group containing that ad site.

In another facet of the present concepts, the conversion-probability estimator may be further configured to define the statistic S(ψ) in the definition of the Bayesian value generator as the mean of the distribution ψ.

The systems and methods of the present concepts may also be designed with an additional bid generator that produces bids for the bid uploader in place of the bid generator. This additional bid generator raises bids on some ad sites for which little performance information is available in an attempt to spend a user-specified amount of money per reporting period searching for high-performing ad sites, and it emits very low bids for ad sites that have not been chosen for bidding up and have not shown evidence of decent performance. For ad sites the additional bid generator does not choose to raise or lower in these ways, it passes through unchanged the bids of the aforementioned bid generator. In one embodiment, the system interacts only with ad services that define position, and if the system does not include components that analyze the relationship of bids with positions and the behavior of volume, this system expressly further comprises such components.

While the best modes for carrying out the present invention have been described in detail, those familiar with the art to which this invention relates will recognize various alternative designs and embodiments for practicing the invention within the scope of the appended claims.

1. A system for calculating an estimate of a relationship between position and bid for at least one ad site on an ad service defining position, the system comprising:
a cost-side reporter configured to receive input signals from the ad service, to generate data relating to activity of the at least one ad site, and to output signals indicative thereof, the activity comprising position information and bid information for one or more reporting periods; and
a computer operatively connected to the cost-side reporter to receive the output signals therefrom;
wherein the computer is programmed and configured to determine a suitable weighted central statistic of weighted points for at least one ad position on the at least one ad site based at least in part on the data of activity of the at least one ad site for at least one of the one or more reporting periods; and
wherein the computer is further programmed and configured to convert a function associating each position to its weighted central statistic into a similar monotonic function.

2. The system of claim 1, wherein the weighted central statistic of weighted points is one of a weighted median and a weighted mean.

3. The system of claim 1, wherein the computer is further programmed and configured to receive as input a tree of properly nested groups of ad sites, and generate a central statistic for each of the groups in the tree of properly nested groups by structural induction over the tree of properly nested groups.

4. The system of claim 1, wherein the computer is further programmed and configured to receive as input a set of groups characterized in that the set of groups are not properly nested, and generate a central statistic for the at least one ad site by traversal of a hypercube lattice of repeated intersections of groups containing the at least one ad site.

5. The system of claim 1, wherein the at least one ad site on the ad service is characterized as a text string, and wherein the computer is further programmed and configured to receive as input a set of ad sites characterized in that no additional structure is given for the set of ad sites, and generate a set of groups of the set of ad sites related by containing a common substring, the common substring comprising a word of reasonable length.

6. The system of claim 1, wherein the at least one ad site on the ad service is characterized as a text string, and wherein the computer is further programmed and configured to receive as input a set of ad sites characterized in that no additional structure is given for the set of ad sites, and generate a set of groups of ad sites related by having a predetermined Levenshtein distance between each pair of ad sites in the set of groups of ad sites.

7. The system of claim 6, wherein the computer utilizes a preclassification by bit vectors to generate the set of groups of ad sites if the input set of ad sites exceeds a predetermined size.

8. An ad-campaign management system, comprising:
a cost-side reporter configured to receive input signals from an ad service, to generate data relating to activity of at least one ad site, and to output signals indicative thereof, the activity comprising chargeable events;
a revenue-side reporter configured to receive input signals from an external system, generate data relating to conversions associated with chargeable events at the at least one ad site, and to output signals indicative thereof;
a Bayesian value generator operatively connected to the cost-side and revenue-side reporters to receive output signals therefrom, and configured to generate an estimated average value of a chargeable event on the at least one ad site and output signals indicative thereof, the Bayesian value generator comprising:
a conversion-probability estimator configured to generate data including an estimated conversion probability for the at least one ad site and output signals indicative thereof;
a conversion-value estimator configured to generate data including the estimated average value of a conversion on the at least one ad site and output signals indicative thereof; and
an information-value estimator configured to generate data including an estimated monetary equivalent value; and
a bid generator operatively connected to the cost-side reporter, revenue-side reporter, and Bayesian value generator to receive output signals therefrom, and configured to calculate a bid to be applied to the at least one ad site, and output a signal bearing data relating to the calculated bids.

9. The system of claim 8, wherein the bid generator is further configured to output the estimated average value computed by the Bayesian value generator multiplied by a user-configurable constant parameter.

10. The system of claim 8, wherein the conversion-value estimator is further configured to output the following for every ad site: an average revenue on a conversion, extending the average revenue over all conversions in the campaign as well as the one or more additional values received as input or user-configurable parameters.

11. The system of claim 8, further comprising a greedy-allocation bid generator configured to calculate a cost and revenue expected from a sampling of bidding levels for the at least one ad site, and further configured to determine a set of bids that efficiently allocate spending among the ad sites as determined by a greedy algorithm, and wherein the bid generator is further configured to output the values computed by the greedy-allocation bid generator.

12. The system of claim 8, wherein the information-value estimator is further configured to output a value of zero uniformly for the at least one ad site.

13. The system of claim 8, further comprising a computer configured to calculate an information value for the at least one ad site based on a total of chargeable events and conversions by embedding the valuation problem in a Markov decision process.

14. The system of claim 8, further comprising a computer configured to fit a model function to data on a total of chargeable events and conversions on the at least one ad site by optimizing the logarithm of a maximum likelihood estimator through a variant of a simulated-annealing simplex method modified to handle inequality constraints.

15. The system of claim 14, wherein the model is taken piecewise-linear and the objective function is an objective function plus a penalty term.

16. The system of claim 8, further comprising a bid uploader operatively connected to the bid generator to receive output signals therefrom, and configured to transmit the calculated bids to the ad service.

17. The system of claim 8, wherein the conversion-probability estimator is further configured to specify a fixed statistic and a prior distribution for the at least one ad site, and wherein generating the data including the estimated conversion probability is based at least in part upon the fixed statistic and prior distribution.

18. The system of claim 17, wherein the conversion-probability estimator is configured to define a statistic as the mean of a distribution in the generating of the estimated average value.

19. The system of claim 8, wherein the conversion-value estimator is further configured to output an average revenue on a conversion, and extend the average revenue over all conversions observed in a campaign.

20. The system of claim 8, wherein the conversion-probability estimator is configured to define a statistic S(ψ) as the q-quantile of the distribution ψ, where 0<q<1 is a user-configurable parameter.
